(19) United States
(12) Patent Application Publication
(10) Pub. No.: US 2007/0024241 A1
(43) Pub. Date: Feb. 1, 2007

(54) Battery monitoring circuit and method

(76) Inventors: Heather N. Bean, Fort Collins, CO (US); Peter A. Millett, Longmont, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,385

(22) Filed: Jul. 26, 2005

(51) Int. Cl. H02J 7/00

(52) U.S. Cl. 320/132

(57) ABSTRACT

Devices and methods that monitor batteries used in electronic devices are disclosed herein. An embodiment of a device comprises a sample and hold circuit connected between terminals of the battery, wherien the sample and hold circuit comprising a sample and hold output. A comparator comprising a comparator input connected to the sample and hold output and a comparator output. The state of the comparator output changes when the potential of the comparator input crosses a preselected voltage threshold. A processor comprising a processor input is connected to the comparator output. The processor initiates a shut down of the electronic device upon a change of state of the comparator output.

### BACKGROUND

Many electronic devices include processors and other associated components that may lose data or malfunction if they are powered down or shut down improperly. For example, if the processor is processing data during the improper shut down, the data may become corrupt and may be unreadable. If the data being processed during the improper shut down is related to the operating system, the operating system may not function. Accordingly, the processor and the, thus, the electronic device, will not function.

Many electronic devices are powered by the use of batteries. The power output of different types of batteries vary enormously. In addition, different batteries drain or discharge differently. For example, lithium batteries drain differently than alkaline batteries. In addition, hot batteries drain differently than cold batteries and their internal resistances are different. Therefore, their abilities to provide a constant voltage source during abrupt current draws are different. Based on these and other differences, it is possible that two batteries have the same voltage under light current loading, but under high current loading, their voltages differ. The voltage of a battery having high internal resistance may fall below the operative voltage of a processor being powered by the battery while the voltage of a battery having low internal resistance does not.

Based on the foregoing, it is difficult to predict when a battery powered device should be properly powered down in anticipate of that the battery may not be able to sustain a proper operating voltage during heavy current drain.

Electronic devices monitor the average battery voltage and chose a relatively high voltage as a threshold to initiate a powering down procedure. Based on the relatively high threshold voltage, some devices may be prematurely shut down.

Other devices may not be properly shut down in time, which may cause the an improper shut down due to the voltage of the battery falling below the operating voltage of the device.

### BRIEF DESCRIPTION OF THE DRAWINGS

FIG. 1 is a graph depicting voltage drain of a plurality of batteries over time.

FIG. 2 is a flow chart describing an embodiment for monitoring battery voltage.

FIG. 3 is a block diagram of an embodiment of a circuit for monitoring battery voltage.

FIG. 4 is a block diagram of an embodiment of a circuit for monitoring battery voltage.

### DETAILED DESCRIPTION

Many electronic devices, including digital cameras, use batteries to supply electric power. Many of these electronic devices have processors and associated memory circuits that need to be powered down properly in order to avoid losing data stored in the memory. If the processor is active when power is improperly removed, data stored in the memory may be lost or corrupt. If the data is required to operate the processor, the processor may fail during subsequent operation of the electronic device. Improper powering down of the electronic device includes situations of the battery voltage dropping wherein the electronic device is unable to operate.

Determining when a battery is becoming discharged or drained to the point where it cannot reliably operate an electronic device and an improper shut down is likely to occur is difficult. One factor affecting battery performance is internal resistance, which vary between batteries. In addition, different operating conditions, such as operating temperatures, can change the internal resistance. As the current load on the battery increases, the voltage across the internal resistance increases, which reduces the voltage available to the electronic device. Eventually, the current load will lower the battery voltage to a point where the electronic device improperly shuts down.

One method of determining when batteries cannot power electronic devices is by simply monitoring the battery voltage or average voltage. However, transients caused by sudden current draws may reduce the battery voltage below the operating voltage of the electronic device even though the average battery voltage is above the operating voltage of the electronic device. Sophisticated electronic devices, such as digital cameras, include several components that draw sudden high current such as a processor, memory, motors for focusing, a display, and a flash. Therefore, a measure of average battery voltage for such a device may not accurately predict when the device should be properly shut down so as to avoid an improper shut down.

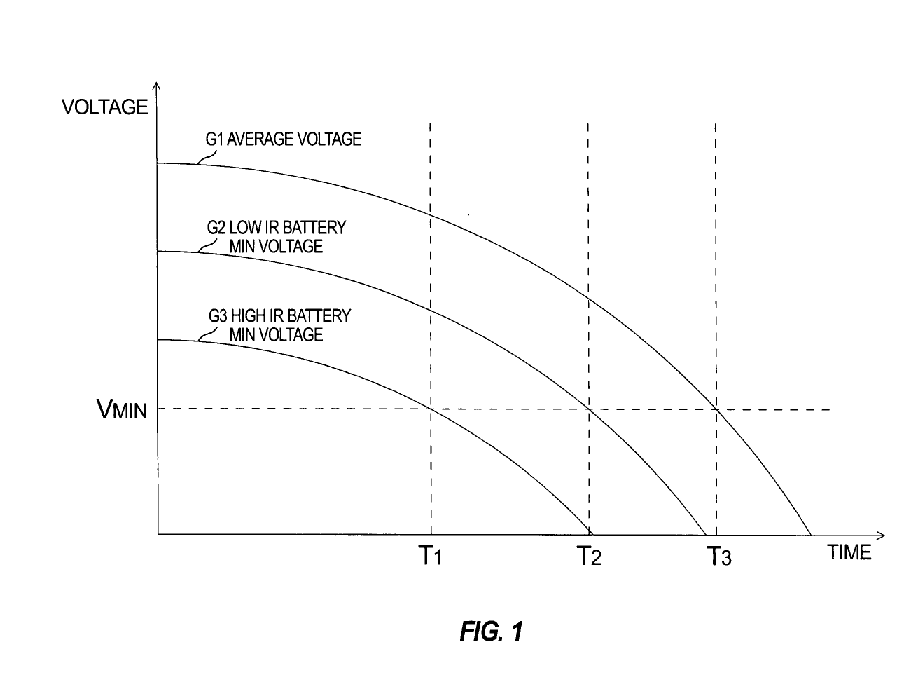

In order to overcome this problem, conventional electronic devices initiate a proper shut down at a voltage wherein it is unlikely that a transient will cause an improper shut down. This voltage is typically set high in order to encompass batteries with high internal resistance. An example of such a voltage for shut down is shown by the graphs of FIG. 1. The vertical axis of FIG. 1 is voltage and the horizontal axis is time. A minimum voltage noted as V_{MIN} is the minimum voltage that is required to operate the electronic device. A graph G1 depicts the drain of a battery having a relatively low internal resistance. It is noted that the graph G1 is reflective of the minimum voltage of the battery due to the above-described transients caused by current draw. The graph G2 depicts the drain of a battery having a relatively high internal resistance and under the same load as the battery depicted by the graph G1. The graph G2, like the graph G1, is reflective of the minimum voltage of the battery due to the above-described transients.

The circuits and methods described herein measure battery voltage. More specifically, they measure dips in voltages or minimum voltages of a battery to determine when a device powered by the battery should be shut down. These dips are sometimes referred to as minimum battery voltages and transients. When the minimum voltages are below a preselected value, a signal may be generated to cause an electronic device being powered by the battery to shut down before the electronic device is improperly shut down by loss of battery power. In some embodiments, a user is notified to properly shut down the electronic device. In other embodiments, the device is automatically and properly shut down.

The use of monitoring the minimum voltages of a battery typically extends the time in which the device may be used without the need to initiate a shut down. If the average battery voltage is monitored, the electronic device is shut down at time T1 or a time before T1 because it is assumed that the battery is a worst case, high resistance battery. Using the methods and circuits described herein, the lowest voltage of the battery is measured. Therefore, if the battery is a low resistance battery as depicted by the graph G1, the time before a shut down is initiated is extended to T2.

Having summarily described some embodiments of the methods, they will now be described in greater detail.

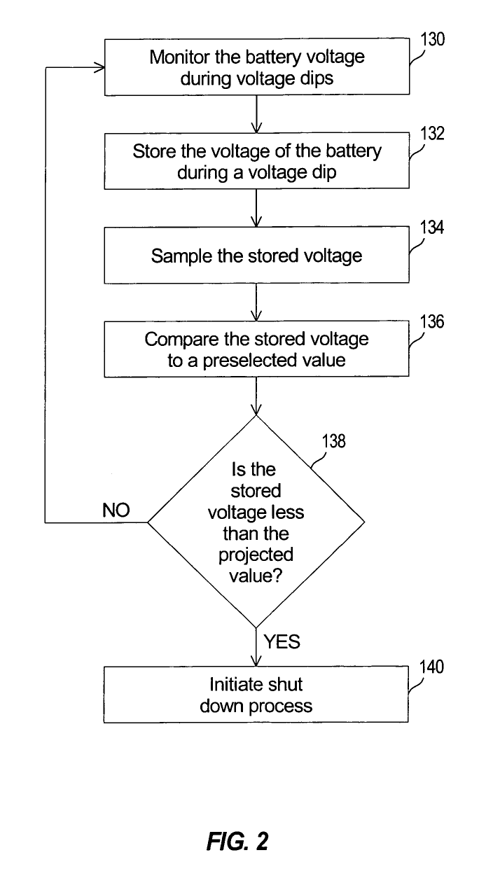

A flowchart describing an embodiment of the method is shown in FIG. 2. At block 130, the battery voltage is monitored during voltage dips or transients.

It is noted that the battery voltage may be constantly monitored, which would include monitoring the voltage during the voltage transients. At block 132, the voltage level of the battery during a voltage transient is stored. It is noted that the voltage stored at block 132 may be an approximate voltage of the battery or proportional to the voltage of the battery during the transient.

The stored voltage of the battery is sampled at block 134. In one embodiment the battery voltage is converted to a digital number where a processor measures or samples the voltage. In one embodiment, the battery supplies power to the processor wherein the processor may process other data associated with the electronic device. In the embodiment wherein the electronic device is a digital camera, the processor may be the same processor within the digital camera that processes image data and performs other functions of the digital camera.

The sampled voltage is compared to a reference voltage at block 136. It is noted that the voltage stored at block 132 may be compared to the reference voltage at block 136, thus eliminating the sampling at block 134. The above-described processor may perform the comparing function of block 136. The reference voltage may be a voltage slightly greater than the minimum voltage required to operate the electronic device that is powered by the battery. Therefore, as described in greater detail below, before the voltage transients approach the minimum voltage required to operate the electronic device, the electronic device may be properly powered down.

Decision block 138 decides whether the sampled voltage is less than the reference voltage. It is noted that block 136 and decision block 138 may be performed in substantially the same operation and both may be performed by the above-described processor. If the measured voltage is not less than the reference voltage, processing returns to block 130 where the battery voltage is measured. In some embodiments, the battery voltage is continuously measured.

Thus, processing may return to block 134 to sample another measured voltage.

If decision block 138 determines that the measured voltage is less than the reference voltage, processing proceeds to block 140. At block 140 a shut down procedure is initiated. Several such procedures may be used. For example, the user may be notified via a signal that the battery is low and that the electronic device needs to be shut down properly. In addition or as an alternative, the electronic device may shut itself down. These shut downs are proper and do not cause harm to the electronic device or any data stored therein.

It is noted that the measurements and comparisons described above are based on voltage transients rather than the average voltage of the battery. Thus, if a battery has an average voltage that would power the electronic device under normal current loads, but cannot maintain the minimum voltage during high current loads, the electronic device may be properly shut down without being shut down via a loss of power. Thus, monitoring voltage transients provides a more accurate measurement of battery performance.

Having described some embodiments of the methods of monitoring a battery, some circuits that perform the methods will now be described.

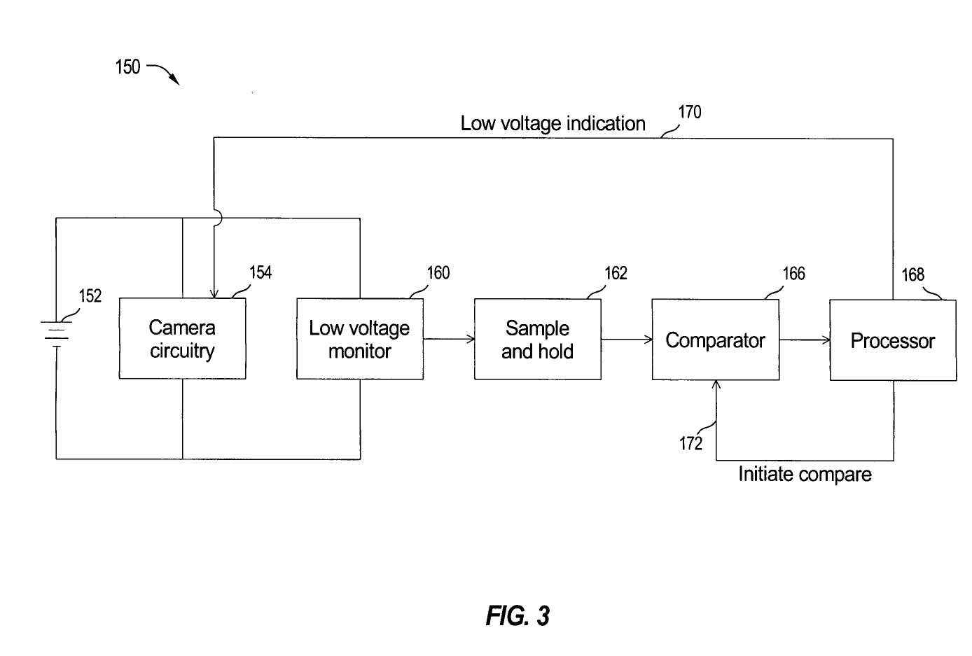

FIG. 3 shows a block diagram of an embodiment of a circuit 150 for monitoring a battery 152. In the embodiment of the circuit 150, the battery 152 is used to provide electric power to camera circuitry 154. The camera circuitry 154 may include processors, memory, a flash, motors for zooming, and other camera components.

The circuit 150 includes a low voltage monitor 160 that monitors the voltage of the battery 152. More specifically, when the camera circuit 154 draws current to cause a transient, the voltage is monitored by the low voltage monitor 160. As set forth above, the lowest voltage of the battery 150 during a transient is proportional, in part, to the internal resistance of the battery 150. An output of the low voltage monitor 160 is connected to an input of a sample and hold circuit 162. The low voltage is stored by the sample and hold circuit 162. The sample and hold circuit 162 may simply hold the voltage so that it may be sampled by a processor or the like as described in greater detail below.

The minimum battery voltage is held at an output of the sample and hold circuit 162. It is noted that the voltage at the output of the sample and hold may be approximately the minimum voltage of the battery 150 or proportional to the minimum voltage of the battery 150. For example, the low voltage monitor 160 may have monitored a voltage close to the minimum voltage of the battery 150. In some embodiments, the low voltage monitor 160 may not be fast enough to monitor the absolute lowest voltage. Also, in some embodiments the sample and hold circuit 162 may include a voltage divider or amplifier so the sampled voltage may be proportional to the low voltage.

In some embodiments, the low voltage monitor 160 is incorporated into the sample and hold circuit 162. In such embodiments, the sample and hold circuit 162 may sample the voltage of the battery 150 and hold lowest voltages for analysis.

The output of the sample and hold circuit is connected to a comparator 166. The comparator compares the voltage of the sample and hold circuit 162 to a reference voltage. It is noted that the voltage of the sample and hold circuit 162 may be converted to a digital number. Thus, the comparator 166 may be incorporated with a processor, such as the processor 168, which is described in greater detail below. The reference voltage is slightly greater than the minimum voltage required to operate the camera circuitry 154. With respect to the graph of FIG. 1, the reference voltage is slightly greater than the voltage V_{MIN}. It should be noted that the reference voltage could be V_{MIN}, however, this may cause the device to shut down improperly before the proper shut down is initiated. The amount that the reference voltage exceeds V_{MIN} may vary and depends on several design criteria of the device, such as the magnitude of the expected transients and expected battery performance.

A processor 168 connected to the output of the comparator 166 analyzes the results of the comparison. For example if the sample and hold voltage exceeds the reference voltage, the output of the comparator 166 may be in a first state. Likewise, the output of the comparator 166 may be in a second state if the sample and hold voltage does not exceed the reference voltage. The processor 168 analyzes the output of the comparator 166 and initializes a proper shut down if the sample and hold voltage is less than the reference voltage. In one embodiment, an instruction is sent to the camera circuitry 154 to cause the proper shut down. The initiation of the shut down may include an indication to the user that the battery voltage is low. The initiation may also include actually shutting down the device without user intervention.

As with the comparator 168, the processor 186 may be the processor or use the processor within the camera or other devices powered by the battery 150. Thus, both the processor 168 and the comparator 166 may be computer programs residing in hardware, software, or firmware in the camera or other device. In such a situation, the process of comparing and checking the voltage of the sample and hold circuit 162 requires processing time, which reduces the time the processor has for other functions. In order to overcome this problem, the processor 168 may initiate compare commands via a line 172. For example, the sample and hold circuit may hold the battery voltage for one hundred milliseconds. The compare function may be commenced every ten milliseconds, which may not interfere with other functions of the processor.

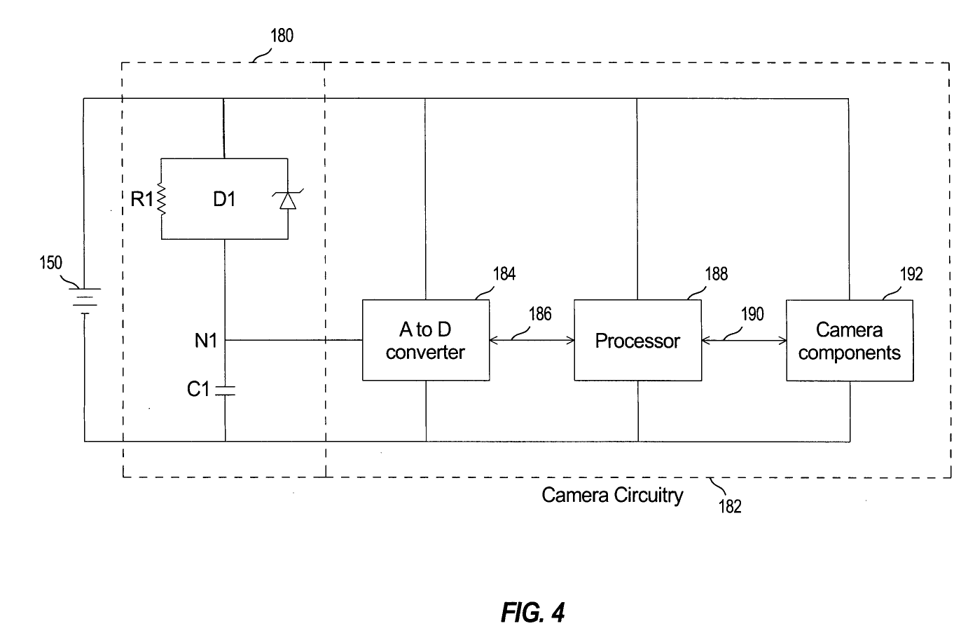

A more detailed embodiment of a circuit 180 for monitoring the battery 150 is shown in FIG. 4. The circuit 180 monitors minimum voltages of the battery 150. The battery 150 serves to provide power to camera circuitry 182. It is noted that the battery 150, the circuit 180, and the camera circuitry 182 may all be located within a camera housing. It is also noted that while the circuit 180 is associated with a camera, it could be associated with a plurality of other electronic devices.

The circuit 180 includes a resistor R1 connected between the positive terminal of the battery and a node N1. A diode D1 is connected in parallel with the resistor R1. The cathode of the diode D1 is connected to the positive terminal of the battery 150 and the anode is connected to the node N1. In one embodiment the resistor R1 has a value of approximately one hundred kilohms and the diode D1 is a Schottky diode. A capacitor Cl is connected between the node N1 and the negative terminal of the battery 150.

In the embodiment of FIG. 4, the camera circuitry 182 includes the components that process the minimum voltages of the battery 150. The camera circuitry 182 includes an analog to digital (A/D) converter 184, which is connected to a processor 188 via a data line 186. The camera circuitry 182 may also include camera components 192 which are connected to the processor via a data line 188. Both the data line 186 and the data line 188 may include a plurality of data lines. The camera components 192 may include memory, a CCD, a flash, and other components used to capture digital images. The processor 188 may control the camera components 192 in a conventional manner. The processor 188 may also process image data captured by the camera.

During operation of the camera without any transients, the capacitor C1 charges to the voltage of the battery 150. When the camera circuitry 182 incurs a sudden current draw, the internal resistance of the battery 150 will cause a negative or downward transient on the output of the battery 150. The capacitor C1 then discharges through the diode D1 so that the voltage of the capacitor C1 is substantially the same as the transient voltage of the battery 150. In some embodiments, the forward voltage of the diode D1 is very low so that the voltage of the capacitor C1 is closer to the voltage of the battery 150 during the transient.

After the transient, the capacitor C1 slowly charges via the resistor R1. The time constant of the RC circuit of resistor R1 and capacitor C1 is long enough to hold the transient voltage on the capacitor C1 until it can be sampled or otherwise measured. In one embodiment, the time constant is approximately one hundred milliseconds and the voltage of C1, which may be measured at node N1, is sampled approximately every ten milliseconds. In some embodiments, the voltage at node N1 is measured at least once within the time constant.

The A/D converter 184 converts the voltage of the capacitor C1 to a binary number. The A/D converter 184 may continuously convert the voltage or it may perform the conversion upon a instruction from the processor 188. Because the voltage at node N1 is converted to a binary number, the processor 188 can compare the binary number to another number that is representative of the above-described reference voltage. As described below, the processor 188 may also compare the voltage of node N1 to several different reference voltages.

As set forth above, the processor may be operating the camera and processing image data in addition to monitoring the voltage of the battery 150. Therefore, the processor 188 will likely be too busy to continuously monitor the battery voltage. The capacitor C1 maintains the lowest voltage of the battery by way of the time constant. The time constant, in some embodiments, is ten times greater than the period in which the processor 188 samples the voltage. Thus, the lowest battery voltage is held until the processor 188 has time to analyze it.

If the voltage at node N1 is less than the reference voltage, the processor may initiate a shut down or power down procedure. This initiation may simply notify the user to shut down the camera or the processor may shut down the camera without user intervention.

Having described some embodiments of the battery monitoring methods and circuits, other embodiments will now be described. In some embodiments, the minimum battery voltage is compared to several different reference voltages. A first reference voltage may be a first amount greater than the minimum voltage required to operate the camera. A second reference voltage may be closer to the minimum voltage required to operate the camera. If the voltage at node N1 is less than the first reference voltage, the processor 182 may simply provide some indication that the battery voltage is low. If the voltage at node N1 is below the second reference voltage, an improper shut down may be about to occur because the minimum battery voltage is getting low. At this time, the processor 182 may cause the camera to shut down without user intervention in order to avoid an improper shut down.

1. A battery monitoring device, wherein a battery is connectable to an electronic device, said battery monitoring device comprising:
a sample and hold circuit connectable between terminals of said battery, said sample and hold circuit comprising a sample and hold output, wherein said sample and hold circuit monitors the voltage of said battery and holds at least one voltage corresponding to downward voltage transient;
a comparator having a comparator input and a comparator output, said comparator input being connected to said sample and hold output, the state of said comparator output changes when the voltage of said comparator input decreases below a preselected voltage threshold; and
a processor comprising a processor input connected to said comparator output, wherein said processor initiates a shut down of said electronic device upon a change of state of said comparator output.

2. The device of claim 1, wherein said electronic device is a camera.

3. (canceled)

4. The device of claim 1, wherein said sample and hold circuit comprises a resistor connected between a first terminal of said battery and a node, a diode connected in parallel with said resistor, and a capacitor connected between said node and a second terminal of said battery; said sample and hold output being said node.

5. The device of claim 4, wherein the time constant of said resistor in series with said capacitor is approximately one hundred milliseconds.

6. The device of claim 4, wherein said processor analyzes said comparator output at of at least once within the time constant of said resistor and said capacitor.

7. The device of claim 6, wherein rate that said processor analyzes said comparator output is approximately one tenth of said time constant.

8. The device of claim 1 and further comprising an analog to digital converter connected between said sample and hold circuit and said comparator, said digital to analog converter converting the analog voltage of the sample and hold output to a digital number.

9. The device of claim 1, wherein said processor provides an indication of a low battery upon a change of state of said comparator output.

10. The device of claim 1, wherein said processor shuts down said electronic device upon a change of state of said comparator output.

11. A battery monitoring device, wherein a battery is connectable to an electronic device, said battery monitoring device comprising:
a sample and hold circuit connectable between terminals of said battery, said sample and hold circuit comprising a sample and hold output, wherein said sample and hold circuit monitors the voltage of said battery and holds at least one voltage corresponding to downward voltage transient;
an analog to digital converter comprising an analog input and a digital output, said analog input being connected to said sample and hold output; and
a processor comprising a processor input connected to said digital output of said analog to digital converter, wherein said processor initiates a first shut down procedure of said electronic device when the voltage of said sample and hold output is below a first reference voltage.

12. The device of claim 11, wherein said first shut down procedure comprises providing an indication that the voltage of said battery is low.

13. The device of claim 11, wherein said first shut down procedure comprises shutting down said electronic device without user intervention.

14. The device of claim 11, wherein said processor initiates a second shut down procedure of said electronic device when the voltage of said sample and hold output is below a second reference voltage.

15. The device of claim 14, wherein said second shut down procedure comprises shutting down said electronic device without user intervention.

16. A method of shutting down an electronic device powered by a battery, said method comprising:
monitoring the voltage of said battery;
storing a voltage of said battery as a result of a voltage transient;
sampling said stored voltage;
comparing the sampled voltage to a first reference voltage; and
initiating a first shut down procedure if said sampled voltage is less than said first reference voltage.

17. The method of claim 16, wherein said initiating comprises providing an indication of the status of said battery.

18. The method of claim 16, wherein said initiating comprises shutting down said electronic device without user intervention.

19. The method of claim 16, and further comprising:
comparing the sampled voltage to a second reference voltage; and
initiating a second shut down procedure if said sampled voltage is less than said second reference voltage.

20. The method of claim 19, wherein said second shut down procedure comprises shutting down said electronic device without user intervention.
